(19) United States
(12) Patent Application Publication
(10) Pub. No.: US 2025/0206630 A1
(43) Pub. Date: Jun. 26, 2025

(54) POROUS SILICA-ALUMINA PARTICLES AND MANUFACTURING METHOD THEREFOR

(71) Applicant: JGC CATALYSTS AND CHEMICALS LTD., Kawasaki-shi, Kanagawa (JP)

(72) Inventors: Yuki MIWA, Wakamatsu-ku, Kitakyushu-shi, Fukuoka (JP); Yuka SETO, Wakamatsu-ku, Kitakyushu-shi, Fukuoka (JP); Tomohiro MITSUI, Wakamatsu-ku, Kitakyushu-shi, Fukuoka (JP)

(73) Assignee: JGC CATALYSTS AND CHEMICALS LTD., Kawasaki-shi, Kanagawa (JP)

(21) Appl. No.: 18/847,311

(22) PCT Filed: Mar. 3, 2023
(86) PCT No.: PCT/JP2023/007945

§ 371 Date: Sep. 16, 2024

(30) Foreign Application Priority Data
Mar. 18, 2022 (JP) 2022-043689

(51) Int. Cl. C01F 7/447

(52) U.S. Cl. CPC C01F 7/447; C01P 2006/12; C01P 2006/14; C01P 2006/17

(57) ABSTRACT

Porous silica-alumina particles in which pores with relatively large diameters are present at a high ratio with respect to the total pore volume, and the particles contain crystalline boehmite alumina, are disclosed. The crystalline boehmite alumina-containing porous silica-alumina particles are such that a specific surface area SA measured by the BET method is in a range of 400 to 600 m²/g, a pore volume PV measured by the BJH method is in a range of 1.0 to 2.2 ml/g, a ratio P10 of a pore volume of pores having pore diameters PD of 10 nm or larger to the total pore volume PV is in a range of 60% or higher, the pore volume of pores having pore diameters of 10 nm or larger being measured by the BJH method, and a mass ratio S/A between silica and alumina is in a range of 2/98 to 70/30.

### CROSS REFERENCE TO RELATED APPLICATIONS

This is the U.S. National Phase application of PCT/JP2023/007945, filed Mar. 3, 2023 which claims priority to Japanese Patent Application No. 2022-043689, filed Mar. 18, 2022, the disclosures of these applications being incorporated herein by reference in their entireties for all purposes.

### FIELD OF THE INVENTION

The present invention relates to porous silica-alumina particles in which pores with relatively large diameters are present at a high ratio with respect to the total pore volume, and the particles contain crystalline boehmite alumina; and a manufacturing method therefor.

### BACKGROUND OF THE INVENTION

Methods for preparing silica-alumina compositions are well known in this technical field, typical examples of which include the neutralization reaction method and the pH swing method.

As the neutralization reaction method (coprecipitation method, co-gelation method), there are disclosed preparation methods capable of producing an amorphous silica-alumina uniformly containing a metal salt therein by mixing silica hydrogel and a metal salt solution, as are the cases in Patent Literatures 1 to 4 and 7.

Further, as the pH swing method (dipping method), there are disclosed preparation methods capable of producing an amorphous silica-alumina in a single container by changing the pH of the reactant mixture and thereby precipitating silica and alumina, as are the cases in Patent Literatures 5 and 6.

### PATENT LITERATURE

Patent Literature 1: Japanese Examined Patent Application Publication No. S27-3989

Patent Literature 2: Japanese Examined Patent Application Publication No. S31-1862

Patent Literature 3: Japanese Examined Patent Application Publication No. S30-5963

Patent Literature 4: Japanese Examined Patent Application Publication No. S32-413

Patent Literature 5: Japanese Unexamined Patent Application Publication (Translation of PCT Application) No. 2010-537808

Patent Literature 6: Japanese Unexamined Patent Application Publication (Translation of PCT Application) No. 2016-502971

Patent Literature 7: Japanese Unexamined Patent Application Publication No. 2021-151942

### SUMMARY OF THE INVENTION

However, with the conventional technique, the porous silica alumina

obtained by the preparation methods described in Patent Literatures 1 to 7 is amorphous silica alumina containing no crystalline alumina.

Moreover, in each case, there was observed a low pore volume ratio of pores having pore diameters of 10 nm or larger. For example, if using porous silica-alumina particles as a catalyst, there may be observed a small diffusion ratio of reactants diffused into pores having diameters smaller than 10 nm.

It is an object of aspects of the present invention to provide porous silica-alumina particles in which pores with relatively large diameters are present at a high ratio with respect to the total pore volume, and the particles contain crystalline boehmite alumina; and a manufacturing method thereof.

Under these technological circumstances, the inventors of the present invention diligently conducted a series of studies to solve the aforementioned problems, and completed aspects of the invention as follows. That is, as a result, the inventors were able to produce crystalline boehmite alumina-containing porous silica-alumina particles in which a pore volume of pores with pore diameters of 10 nm or larger is present at 60% or higher relative to the total pore volume.

Aspects of the invention which were made for the purpose of solving the above problems and achieving the above object are as follows. Specifically, a first aspect of the present invention provides porous silica-alumina particles containing crystalline boehmite alumina, wherein
a specific surface area SA measured by the BET method is in a range of 400 to 600 m²/g,
a pore volume PV measured by the BJH method is in a range of 1.0 to 2.2 ml/g,
a ratio P10 of a pore volume of pores having pore diameters PD of 10 nm or larger to the total pore volume PV is in a range of 60% or higher, the pore volume of pores having pore diameters of 10 nm or larger being measured by the BJH method, and
a mass ratio S/A between silica and alumina is in a range of 2/98 to 70/30.

Here, with regard to the porous silica-alumina particles according to aspects of the present invention, it is considered that more preferred solutions can be brought when the particles further contain alkali metal ions (M⁺) in an amount of 0.1% by mass or smaller in terms of M₂O, and a residual amount of inorganic acid ions is 2.0% by mass or smaller.

Further, a second aspect of the present invention provides a manufacturing method of the aforementioned porous silica-alumina particles. This manufacturing method includes:
a. a step of obtaining a pseudoboehmite alumina hydrate aqueous solution through a preparation step and a maturing and washing step;
b. a step of obtaining a silica hydrogel aqueous solution;
c. a step of obtaining a silica-alumina mixture aqueous solution by preparing a slurry as a result of mixing the silica hydrogel aqueous solution into an aqueous solution containing the pseudoboehmite alumina hydrate aqueous solution and a basic substance, and then by subjecting said slurry to reaction promotion at a temperature of 40 to 95° C. for 10 minutes to 6 hours; and
d. a step of obtaining silica-alumina particles by drying the silica-alumina mixture aqueous solution,
wherein in the maturing and washing step in the step a, maturing is performed by adding an aluminate aqueous solution at a ratio of 10 to 25% by mass in terms of alumina relative to a total amount of alumina.

With the above configuration according to aspects of the present invention, as porous silica-alumina particles, there were obtained crystalline boehmite alumina-containing porous silica-alumina particles in which a pore volume of pores with pore diameters of 10 nm or larger was present at 60% or higher relative to the total pore volume. A high heat insulating property can be achieved with these porous silica-alumina particles. Other than that, since these particles have solid acids, they can be utilized as catalysts and supports for use in petroleum refining and petrochemicals, adsorbents, and optical materials; or be applied to, for example, cosmetics, resin fillers, additive agents for surface coating materials (those that are intended to, for example, adjust optical scattering and refractive indexes).

### DETAILED DESCRIPTION OF EMBODIMENTS OF THE INVENTION

A preferred embodiment of the present invention is described in detail hereunder.

### Porous Silica-Alumina Particles

The porous silica-alumina particles according to aspects of the present invention (which may also be simply referred to as “silica-alumina particles” hereinafter) are porous particles consisting of silica (SiO₂) and alumina (Al₂O₃), in which a pore volume of pores having pore diameters of 10 nm or larger is present at 60% or higher relative to the total pore volume, and the particles are configured as porous silica alumina containing crystalline boehmite alumina.

The porous silica-alumina particles according to aspects of the present invention are crystalline boehmite alumina-containing porous silica-alumina particles. Thus, zeolite or the like as crystalline silica alumina is not included in the silica alumina of the present invention. Whether the silica alumina according to aspects of the present invention is crystalline or not can be determined from an X-ray diffraction pattern. Specifically, in an X-ray diffraction pattern obtained by performing X-ray diffraction measurement on the silica-alumina particles according to aspects of the present invention, it can be said that the particles have crystalline boehmite when diffraction peaks are present in the vicinity of 2θ=15°, 28°, 38°, and 49° that correspond to the miller index planes of (020), (021), (130), and (150) of the boehmite structure, and when the half-value widths of the miller indexes (130), (150) are 1.0° or larger. Further, likewise, it can be determined that the silica-alumina particles according to aspects of the present invention do not contain zeolite if the X-ray diffraction pattern does not show other diffraction peaks whose half-value widths are smaller than 1.0° in a range of 5°≤2θ≤50°.

The silica-alumina particles obtained in accordance with aspects of the present invention are such that a ratio S/A between silica and alumina, which is a mass ratio in terms of SiO₂ and Al₂O₃, respectively, is in a range of S/A: 2/98 to 70/30, preferably in a range of S/A: 5/95 to 65/35. When the alumina ratio is lower than S/A: 70/30, the pore volume tends to decrease, whereby a required decomposition rate cannot be achieved when using such particles in a decomposition catalyst or the like. Meanwhile, when the silica ratio is lower than S/A: 2/98, a specific surface area SA tends to decrease.

The obtained silica-alumina particles' specific surface area SA that is measured by the BET method is in a range of 400 to 600 m²/g, preferably in a range of 420 to 550 m²/g. The reason that there are provided lower limits is because if using the particles in a decomposition catalyst, a moderately large specific surface area SA shall be advantageous in view of contactability and reactivity with hydrocarbons.

Meanwhile, a specific surface area SA of larger than 600 m²/g will result in an excessively small pore diameter(s) PD which is even smaller than the molecular size of a hydrocarbon as a reactant, whereby the reactant will be unable to be diffused in the pores such that an effective reaction may not occur.

Further, a pore volume PV that is measured by the BJH method is in a range of 1.0 to 2.2 ml/g, preferably in a range of 1.3 to 2.0 ml/g. When the pore volume PV is smaller than 1.0 ml/g, there will be fewer sites for effectively reacting with hydrocarbon molecules. Meanwhile, a pore volume PV of larger than 2.2 ml/g will result in a small bulk density (ABD) of the powder, which not only leads to a difficult handling property but also causes, for example, a decrease in a catalyst filling amount in a reactor, whereby there may not be achieved an expected performance.

A ratio P10 of a pore volume of pores having pore diameters of 10 nm or larger to the total pore volume PV is 60% or higher, preferably 65% or higher; the pore volume of pores having pore diameters of 10 nm or larger is measured by the BJH method. The ratio P10 may be 100%. When there is a high ratio of a pore volume of pores having pore diameters of smaller than 10 nm, an effective reaction may not occur as the reactant is unable to be diffused in the pores. Further, an average pore diameter PD is preferably in a range of 8 to 25 nm (80 to 250 Å), more preferably in a range of 10 to 20 nm (100 to 200 Å). The reason that there are provided lower limits is because when the average pore diameter PD is excessively small, there will be more pores that are smaller than the molecular size of a hydrocarbon as a reactant, which makes it impossible for the reactant to be diffused in the pores and thereby results in a concern that an effective reaction may not occur. Meanwhile, the reason that there are provided upper limits is because a decrease in the specific surface area SA may lead to deterioration in active sites of the decomposition reaction.

The silica-alumina particles according to aspects of the present invention are also characterized by having a small residual amount of cationic and anionic impurity ion components. Examples of residual cations include alkali metal ions such as residual sodium ions and potassium ions. The amount of these alkali metal ions (M⁺) is 0.1% by mass or smaller, preferably 0.05% by mass or smaller in terms of M₂O. Further, the residual amount of inorganic acid ions such as sulfate ions and nitrate ions is 2.0% by mass or smaller, preferably 1.8% by mass or smaller. By reducing these impurity ion components, poisoning of solid acid sites and active metals can be suppressed.

### Manufacturing Method of Porous Silica-Alumina Particles

<a. Step of Obtaining Pseudoboehmite Alumina Hydrate Aqueous Solution>

### a-1. Preparation Step (First Step)

Methods for preparing pseudoboehmite alumina particles are widely known, of which preferred is a method for producing a precipitation of pseudoboehmite alumina particles by neutralizing a solution of an aluminum salt and/or an aluminate. As an aluminum salt, there may be used any aluminum salt such as aluminum sulfate, aluminum chloride, and aluminum nitrate. Further, as an aluminate, there may be used any aluminate such as sodium aluminate and potassium aluminate. The neutralization reaction may be performed by any of a method of adding an alkaline aqueous solution such as a sodium hydroxide aqueous solution, a potassium hydroxide aqueous solution, and ammonia water to an aluminum salt aqueous solution; a method of adding an aqueous solution of an acid such as sulfuric acid, hydrochloric acid, and nitric acid to an aluminate aqueous solution; and a method of mixing an aluminum salt aqueous solution and an aluminate aqueous solution. However, from the perspective of production cost, preferred is a method of obtaining a pseudoboehmite alumina hydrate aqueous solution by mixing an aluminum salt aqueous solution and an aluminate aqueous solution.

After mixing the two solutions for the sake of neutralization reaction, the pH of the solution is adjusted to a range of 5.0 to 8.0, and the temperature of the solution is adjusted to a range of 30 to 70° C., for the purpose of promoting the reaction to obtain a pseudoboehmite alumina hydrate. Next, with a short reaction time of less than an hour, a precursor of the hydrate is at first formed, followed by further repeating the aforementioned neutralization reaction to promote the reaction, thereby obtaining the pseudoboehmite alumina hydrate. If the pH of the solution prepared is out of the above range, there is a concern that the pore volume of the pseudoboehmite alumina particles eventually obtained may decrease.

It is preferred that the temperature of the prepared solution be in the range of 30 to 70° C. When the temperature is lower than 30° C., the particles tend to agglomerate firmly, whereby a powdery body obtained through a maturing and drying step may exhibit a small pore volume. Further, a temperature of higher than 70° C. is not preferable, because bayerite will be precipitated easily. A maturing time is preferably in a range of 5 to 60 min, more preferably 5 to 30 min. When the maturing time is out of these ranges, there is a concern that the pore volume of the pseudoboehmite alumina particles eventually obtained may decrease.

### a-2. Maturing and Washing Step (Second Step)

Maturing is performed by adding an aluminate solution to the pseudoboehmite alumina hydrate aqueous solution. The addition ratio of the aluminate aqueous solution in the maturing step in terms of alumina is in a range of 10 to 25% by mass relative to a total amount (charged amount) of alumina. When the addition ratio in terms of alumina in this step is lower than 10% by mass, the boehmite crystal phase will not be generated, whereby the ratio of the pore volume of pores of 10 nm or larger will be smaller, and the average pore diameter will also be smaller. Meanwhile, there is only a small effect even when the addition ratio is greater than 25% by mass; rather, when the addition ratio is greater than 25% by mass, agglomeration of the pseudoboehmite alumina will proceed, whereby the pore volume may decrease.

It is desired that a maturing temperature be in a range of 40 to 95° C., more preferably in a range of 50 to 80° C. When the maturing temperature is lower than 40° C., the pore volume of the pseudoboehmite alumina obtained may decrease. Meanwhile, when the maturing temperature is higher than 95° C., crystal growth of alumina will proceed, whereby the specific surface area SA and the pore volume PV may decrease.

There are no particular limitations on a maturing time; in view of production efficiency, it is preferred that the maturing time be 240 min or less. If the maturing time is excessively long, the specific surface area SA of the pseudoboehmite alumina particles eventually obtained tends to be small.

An alumina cake 1 is obtained after filtering out a solid content from the matured pseudoboehmite alumina aqueous solution. This alumina cake 1 is then moved to a washing container so as to be washed by water of 50 to 70° C., thereby eliminating unreacted raw materials, impurity ions and the like, thus obtaining an alumina cake 2. In order to eliminate unreacted salts, washing may be carried out using ammonia water, ammonium hydrogen carbonate or the like.

The alumina cake 2 obtained is then dispersed in water to prepare a pseudoboehmite alumina hydrate aqueous solution.

<b. Step of Obtaining Silica Hydrogel Aqueous Solution>

Methods for preparing silica hydrogel are widely known; particularly, pH during preparation can be controlled by adjusting the supply rates of a silicate aqueous solution and an acid, and a SiO₂ concentration can be controlled by employing a silicate aqueous solution and acid with concentrations that have been previously calculated and determined.

The reaction is performed in such a way that the silicate aqueous solution and acid are supplied while performing stirring in a reactor that is maintained at a temperature of 10 to 100° C., preferably 20 to 95° C., thereby obtaining a silica hydrogel solution.

As the silicate, there may be used any of, for example, soluble silicates such as silicate sodas No. 1, No. 2, No. 3, and potassium silicate; and diatom earth.

As the acid, there may be used either an inorganic acid such as sulfuric acid, nitric acid, hydrochloric acid, and phosphoric acid; or an organic acid such as formic acid. An inorganic acid is preferred.

The concentration of the silicate supplied is 30% by mass or lower, preferably 10% by mass or lower, in terms of SiO₂. Although a lower limit of the silicate's concentration is not particularly provided, it is preferred if the silicate is supplied at a concentration of, for example, 5% by mass or higher because there is no need to employ a large-volume preparation container and a large amount of water that are required to adjust and achieve a required amount of SiO₂. In contrast, the reason that there is provided an upper limit is because a stirrer will stop or become unable to sufficiently perform stirring due to an overload that is caused by the impact of a strong gel-like substance produced by gelation that occurs when neutralized with the inorganic acid.

Before use, the silica hydrogel aqueous solution obtained may be washed by water of 40 to 70° C. in order to eliminate unreacted raw materials, impurity ions and the like. Further, in order to improve an elimination efficiency of unreacted raw materials, impurity ions and the like, there may also be added, for example, ammonium sulfate, ammonium nitrate, and ammonia, at the time of washing.

With the abovementioned preparation method, there can be easily obtained a silica hydrogel aqueous solution exhibiting a specific surface area SA of 190 to 600 m²/g when measured by the BET method.

Further, there may also be used existing silica particles satisfying such property. Examples thereof may include CARPLEX BS-303 produced by EVONIK Industries AG, and a synthetic quartz powder produced by Mitsubishi Chemical Group Corporation.

The silica particles and the silica hydrogel obtained by the above preparation method may be crushed by a jet mill, a bead mill or the like before use.

<c. Step of Obtaining Silica-Alumina Mixture Aqueous Solution>

A silica-alumina mixture aqueous solution is obtained by mixing the pseudoboehmite alumina hydrate aqueous solution and the silica hydrogel aqueous solution.

The silica-alumina mixture aqueous solution can be obtained by mixing the silica hydrogel aqueous solution and the pseudoboehmite alumina hydrate aqueous solution whose solid content concentration has been adjusted to 1 to 10% by mass, and then maturing the mixed solution at a temperature of 40 to 95° C. for 10 minutes to 6 hours. When mixing these two solutions, it may be that the silica hydrogel aqueous solution is added to the pseudoboehmite alumina hydrate aqueous solution, or that the pseudoboehmite alumina hydrate aqueous solution is added to the silica hydrogel aqueous solution.

It is preferred that the pseudoboehmite alumina hydrate aqueous solution be mixed with a basic substance and be used as a solution having a pH of 8.0 to 11.0. An ammonium salt aqueous solution is particularly preferred as the basic substance, examples of which may include ammonium carbonate, ammonium hydrogen carbonate, and ammonia.

<d. Drying Step>

Silica-alumina particles 1 are obtained by drying the silica-alumina mixture aqueous solution obtained in the step c.

In order to obtain the silica-alumina particles 1 by drying, there may be used spray drying or other drying devices that are normally used. While there are no particular limitations on a drying temperature, an excessively high temperature is not preferable because a phase transition from pseudoboehmite alumina to gamma-alumina will occur. For this reason, it is preferred that an inlet temperature be 500° C. or lower, and an outlet temperature be 200° C. or lower; specifically, it is preferred that drying be carried out at an inlet temperature of 300 to 500° C. and an outlet temperature of 130 to 200° C.

<e. Washing-Drying Step>

The silica-alumina particles 1 obtained in the step d may be washed and dried if necessary.

The silica-alumina particles 1 obtained in the step d is again suspended and stirred, followed by performing filtration and washing to obtain a silica-alumina particle cake 2.

In order to reduce the residual alkali metal ion concentration in the silica-alumina particles 1 obtained in the step d, the temperature of the suspension is preferably in a range of 40 to 70° C. Further, it is preferred that the suspension be filtrated with a water-soluble acidic substance-containing aqueous solution. Examples of the water-soluble acidic substance used here include ammonium sulfate, ammonium nitrate, and ammonium chloride.

Moreover, in order to eliminate residual salts or the like after filtration, washing and filtration are performed with a water-soluble basic substance-containing warm water or the like, thereby obtaining the silica-alumina particle cake 2. In order to improve an elimination efficiency of unreacted raw materials, impurity ions and the like, the temperature of the washing water is preferably in a range of 50 to 70° C. which is higher than normal temperature. Examples of the water-soluble basic substance used here include ammonia water, hydroxide salts, carbonates, and hydrogen carbonates (salts mentioned here refer to alkali metal salts and alkaline-earth metal salts).

<f. Drying Step>

The filtrated silica-alumina particle cake 2 obtained in the step e can be dried by the drying method described in the step d, thereby obtaining target silica-alumina particles 2.

Here, depending on the remaining amount of impurities such as impurity ions, the step d and/or the step e may be performed again after the step e as appropriate.

### Analysis Method of Composition

Here, 3 g of a measurement sample was taken and put into a lid-equipped zirconia ball mill jar having a capacity of 30 ml. After being subjected to a heating treatment (200° C., 20 min) and sintering (700° C., 5 min), 2 g of Na₂O₂ and 1 g of NaOH were added thereto to conduct melting for 15 min. Further, 25 ml of H₂SO₄ and 200 ml of water were added and dissolved therein, followed by diluting the product with pure water so that it would have a volume of 500 ml, thereby obtaining a sample for analysis. The sample thus obtained was subjected to measurements carried out by an inductively coupled plasma (ICP) emission spectrophotometer such as ICPS-8100 manufactured by Shimadzu Corporation, using an analysis software ICPS-8000, where the content of each component was measured on a mass basis in terms of oxides.

The SO₄ content in the sample was measured by a carbon/sulfur analyzer such as CS844 manufactured by LECO Corporation.

### Measurement Method of Specific Surface Area SA

For specific surface area SA measurement, about 30 mL of the measurement sample was taken and put into a magnetic crucible (type B-2), and was then subjected to a heating treatment at a temperature of 600° C. for 2 hours, followed by placing the sample into a desiccator to cool it to room temperature, thereby obtaining a sample for further measurement. Next, 1 g of this sample was taken to measure the specific surface area SA (m²/g) of the sample by the BET method, using a fully automatic surface area measurement device such as Multisorb 12 manufactured by Yuasa Ionics Inc.

### Measurement Method of Pore Volume PV and (average) Pore Diameter PD

The pore volume PV and pore diameter PD were measured by BELSORP-mini Ver 2.5.6 manufactured by MicrotracBEL Corporation. Specifically, a nitrogen gas was adsorbed to a sample that had been heat-treated at 500° C. for 2 hours while performing vacuum evacuation, and the pore volume PV (ml/g) and pore diameter PD (nm) were calculated from a desorption isotherm in the BJH method at a relative pressure of (P/P₀=0.99). Further, there was calculated the ratio of the pore volume P10 of pores having pore diameters of 10 nm or larger to the total pore volume PV.

Furthermore, the average pore diameter PD was calculated by the following formula (A).

$$Average pore diameter PD ( nm ) = Pore volume PV \times 1 {0}^{- 6} ( {m}^{3} / g ) \times 4 / Specific surface area SA ( {m}^{2} / g ) \qquad ( A )$$

### Conditions for X-ray Diffraction Measurement

X-ray diffraction measurement of the silica-alumina particles was performed using MiniFlex manufactured by Rigaku Corporation. The measurement conditions were such that the operation axis was 2θ/θ, the ray source was CuKα, a continuous measurement method was employed in which the voltage was 40 kV, the current was 15 mA, and from a start angle of 2θ=5° to an end angle of 2θ=50°, the sampling width was 0.020°, and the scanning speed was 10.000°/min.

### EXAMPLES

Examples are shown and described in detail hereunder; however, the present invention shall not be limited to these examples.

### Example 1

### Preparation of Pseudoboehmite Slurry (1)

### <First Step>

A 200 L steam-jacketed stainless steel tank was filled with 120 kg of a warm water of 60° C., 48 g of a 25% by mass sodium gluconate aqueous solution was added thereto while performing stirring, and 1.77 kg of a sodium aluminate aqueous solution with a concentration of 22% by mass in terms of Al₂O₃ concentration (by JGC Catalysts and Chemicals Ltd.) was further added thereto to perform mixing for 5 min. Next, 2.95 kg of an aluminum sulfate aqueous solution with a concentration of 7% by mass in terms of Al₂O₃ concentration (by JGC Catalysts and Chemicals Ltd.) was added to perform stirring at 60° C. for 5 min, thereby obtaining a pseudoboehmite slurry precursor (1).

Further, 16.10 kg of the aforementioned sodium aluminate aqueous solution and 29.80 kg of the aforementioned aluminum sulfate aqueous solution were simultaneously added to the pseudoboehmite slurry precursor (1) in a time span of 40 min. Next, stirring was performed for 5 min to obtain a pseudoboehmite slurry (1). The slurry produced exhibited a pH of 6.5.

### Preparation of Pseudoboehmite Washed Slurry (1)

### <Second Step>

Here, 3.85 kg of a sodium aluminate aqueous solution was added to the pseudoboehmite slurry (1), and the slurry was then matured at 60° C. for 2 hours while being stirred. Next, 0.53 kg of a 15% ammonia water was added thereto to perform stirring for 5 min, followed by carrying out dewatering with a flat panel filter, and then washing filtration residues with a warm water of 60° C., thereby obtaining a washed cake. The washed cake was turned into a slurry so that a solid content concentration therein would be 7.2% by mass, thereby obtaining a pseudoboehmite washed slurry (1).

### Preparation of Silica Alumina (1)

Here, 0.08 kg of a 15% ammonia water was added to 22.44 kg of the pseudoboehmite washed slurry (1) to perform stirring for 5 min, followed by adding thereto 3.27 kg of a silica suspension slurry that had been adjusted to 33% by mass in terms of SiO₂ (the silica is such that: average particle size=12 μm; BET specific surface area SA=480 m²/g). The pseudoboehmite washed slurry (1) thus treated was then matured at 50° C. for 2 hours while being stirred. The matured slurry thus obtained was subjected to a dispersion treatment with a homogenizer and dried by a spray dryer at an inlet temperature of 270° C. and an outlet temperature of 130° C., thereby obtaining a silica alumina (1). The properties of the silica alumina (1) are shown in Table 1.

### Example 2

### Preparation of Pseudoboehmite Washed Slurry (2)

A pseudoboehmite washed slurry (2) was obtained in a similar manner as Example 1, except that 6.20 kg of a sodium aluminate aqueous solution was added to the pseudoboehmite slurry (1).

### Preparation of Silica Alumina (2)

A silica alumina (2) was obtained in a similar manner as Example 1, except that there were used 22.44 kg of the pseudoboehmite washed slurry (2). The properties of the silica alumina (2) are shown in Table 1.

### Example 3

### Preparation of Pseudoboehmite Washed Slurry (3)

A pseudoboehmite washed slurry (3) was obtained in a similar manner as Example 1, except that 3.85 kg of a sodium aluminate aqueous solution was added to the pseudoboehmite slurry (1), and that the pseudoboehmite slurry (1) thus treated was then matured at 80° C. for 2 hours while being stirred.

### Preparation of Silica Alumina (3)

A silica alumina (3) was obtained in a similar manner as Example 1, except that there were used 22.44 kg of the pseudoboehmite washed slurry (3). The properties of the silica alumina (3) are shown in Table 1.

### Example 4

### Preparation of Silica Alumina (4)

A silica alumina (4) was obtained in a similar manner as Example 1, except that 0.27 kg of a 15% ammonia water was added to 22.44 kg of the pseudoboehmite washed slurry (1). The properties of the silica alumina (4) are shown in Table 1.

### Example 5

### Preparation of Silica Alumina (5)

Here, 0.08 kg of a 15% ammonia water was added to 35.69 kg of the pseudoboehmite washed slurry (1) to perform stirring for 5 min, followed by adding thereto 0.41 kg of a silica suspension slurry that had been adjusted to 33% by mass in terms of SiO₂ (the silica is such that: average particle size=12 μm; BET specific surface area SA=480 m²/g). The pseudoboehmite washed slurry (1) thus treated was then matured at 50° C. for 2 hours while being stirred. The matured slurry thus obtained was subjected to a dispersion treatment with a homogenizer and dried by a spray dryer at an inlet temperature of 270° C. and an outlet temperature of 130° C., thereby obtaining a silica alumina (5). The properties of the silica alumina (5) are shown in Table 1.

### Example 6

### Preparation of Silica Alumina (6)

Here, 0.27 kg of a 15% ammonia water was added to 11.25 kg of the pseudoboehmite washed slurry (1) to perform stirring for 5 min, followed by adding thereto 14.46 kg of a silica suspension slurry that had been adjusted to 13% by mass in terms of SiO₂ (the silica is such that: average particle size=12 μm; BET specific surface area SA=480 m²/g). The pseudoboehmite washed slurry (1) thus treated was then matured at 50° C. for 2 hours while being stirred. The matured slurry thus obtained was subjected to a dispersion treatment with a homogenizer and dried by a spray dryer at an inlet temperature of 270° C. and an outlet temperature of 130° C., thereby obtaining a silica alumina (6). The properties of the silica alumina (6) are shown in Table 1.

### Comparative Example 1

### Preparation of Pseudoboehmite Washed Slurry (4)

A pseudoboehmite washed slurry (4) was obtained in a similar manner as Example 1, except that 1.28 kg of a sodium aluminate aqueous solution was added to the pseudoboehmite slurry (1).

### Preparation of Silica Alumina (7)

A silica alumina (7) was obtained in a similar manner as Example 1, except that there were used 22.44 kg of the pseudoboehmite washed slurry (4). The properties of the silica alumina (7) are shown in Table 1.

### Comparative Example 2

### Preparation of Silica Alumina (8)

Here, 3.27 kg of a silica suspension slurry that had been adjusted to 33% by mass in terms of SiO₂ (the silica is CARPLEX BS-303 produced by EVONIK Industries AG) were added to 22.44 kg of the pseudoboehmite washed slurry (1), and the pseudoboehmite washed slurry (1) thus treated was then matured at 50° C. for 2 hours while being stirred. The matured slurry thus obtained was subjected to a dispersion treatment with a homogenizer and dried by a spray dryer at an inlet temperature of 270° C. and an outlet temperature of 130° C., thereby obtaining a silica alumina (8). The properties of the silica alumina (8) are shown in Table 1.

### Comparative Example 3

### Preparation of Pseudoboehmite Washed Slurry (5)

The pseudoboehmite slurry precursor (1) was matured at 60° C. for 2 hours while being stirred. Next, 0.53 kg of a 15% ammonia water was added thereto to perform stirring for 5 min, followed by carrying out dewatering with a flat panel filter, and then washing filtration residues with a warm water of 60° C., thereby obtaining a washed cake. The washed cake was turned into a slurry so that a solid content concentration therein would be 7.2% by mass, thereby obtaining a pseudoboehmite washed slurry (5).

### Preparation of Silica Alumina (9)

A silica alumina (9) was obtained in a similar manner as Example 1, except that there were used 22.44 kg of the pseudoboehmite washed slurry (5). The properties of the silica alumina (9) are shown in Table 1.

TABLE 1

| | | | Silica alumina No. | | | | | | | | |
|---|---|---|---|---|---|---|---|---|---|---|---|
| | | | 1 | 2 | 3 | 4 | 5 | 6 | 7 | 8 | 9 |
| Preparation | Charged amount of | | 7.07 | 7.59 | 7.07 | 7.07 | 7.07 | 7.07 | 6.51 | 7.07 | 6.22 |
| of pseudo- | alumina[kg] | | | | | | | | | | |
| boehmine | Second | Addition amount of | 3.85 | 6.20 | 3.85 | 3.85 | 3.85 | 3.85 | 1.28 | 3.85 | |
| | step | sodium aluminate | | | | | | | | | |
| | | aqueous solution [kg] | | | | | | | | | |
| | | Addition amount in | 0.85 | 1.36 | 0.85 | 0.85 | 0.85 | 0.85 | 0.28 | 0.85 | |
| | | terms of alumina[kg] | | | | | | | | | |
| | | Addition ratio in terms | 12 | 18 | 12 | 12 | 12 | 12 | 4 | 12 | |
| | | of alumina [% by mass] | | | | | | | | | |
| | | Maturing | 60 | 60 | 80 | 60 | 60 | 60 | 60 | 60 | 60 |
| | | temperature[° C.] | | | | | | | | | |

| | | | | | | | | | | |
|---|---|---|---|---|---|---|---|---|---|---|
| Preparation of silica | Addition amount | 40 | 40 | 40 | 40 | 5 | 70 | 40 | 40 | 40 |
| alumina | of SiO₂ [% by mass] | | | | | | | | | |
| | Ammonium treatment on | Yes | Yes | Yes | Yes | Yes | Yes | Yes | No | Yes |
| | pseudoboehmite (Yes/No) | | | | | | | | | |

| | | | | | | | | | | |
|---|---|---|---|---|---|---|---|---|---|---|
| Properties | Al₂O₃ [% by mass] | 59 | 59 | 59 | 59 | 93 | 28 | 57 | 59 | 57 |
| | Na₂O [% by mass] | 0.02 | 0.02 | 0.03 | 0.02 | 0.03 | 0.01 | 0.02 | 0.02 | 0.02 |
| | SO₄ [% by mass] | 0.9 | 0.7 | 0.6 | 0.9 | 1.5 | 0.5 | 1.1 | 0.9 | 1.6 |
| | Pore volume [ml/g] | 1.6 | 1.7 | 1.9 | 1.7 | 2.0 | 1.5 | 1.6 | 0.8 | 1.0 |
| | Ratio of pore volume with pore | 66 | 72 | 75 | 66 | 75 | 63 | 56 | 54 | 45 |
| | sizes of 10 nm or larger [%] | | | | | | | | | |
| | Average pore diameter [nm] | 13 | 14 | 15 | 14 | 19 | 12 | 11 | 8 | 9 |
| | Specific Surface Area [m²/g] | 498 | 485 | 500 | 466 | 430 | 512 | 565 | 406 | 443 |
| | Boehmite crystal phase | Present | Present | Present | Present | Present | Present | Absent | Present | Present |
| | (Present/Absent) | | | | | | | | | |

| | | | | | | | | | |
|---|---|---|---|---|---|---|---|---|---|
| Remarks | Invention | Invention | Invention | Invention | Invention | Invention | Com- | Com- | Com- |
| | Example | Example | Example | Example | Example | Example | para- | para- | para- |
| | | | | | | | tive | tive | tive |
| | | | | | | | Example | Example | Example |

### INDUSTRIAL APPLICABILITY

The porous silica-alumina particles according to aspects of the present invention are expected to exhibit a heat insulating property due to the fact that the particles have a high pore volume, a high ratio of pores with relatively large diameters, and crystalline boehmite alumina. Further, other than the aforementioned property, since the porous silica-alumina particles according to aspects of the invention have solid acids as they are composed of silica alumina, they can be utilized as catalysts and supports for use in petroleum refining and petrochemicals, adsorbents, and optical materials; or be applied to, for example, cosmetics, resin fillers, additive agents for surface coating materials (those that are intended to, for example, adjust optical scattering and refractive indexes).

1. Porous silica-alumina particles containing crystalline boehmite alumina, characterized in that
a specific surface area SA measured by the BET method is in a range of 400 to 600 m²/g,
a pore volume PV measured by the BJH method is in a range of 1.0 to 2.2 ml/g,
a ratio P10 of a pore volume of pores having pore diameters of 10 nm or larger to the total pore volume PV is in a range of 60% or higher, the pore volume of pores having pore diameters of 10 nm or larger being measured by the BJH method, and
a mass ratio S/A between silica and alumina is in a range of 2/98 to 70/30.

2. The porous silica-alumina particles according to claim 1, wherein the particles further contain alkali metal ions (M⁺) in an amount of 0.1% by mass or smaller in terms of M₂O, and a residual amount of inorganic acid ions is 2.0% by mass or smaller.

3. A manufacturing method of the porous silica-alumina particles according to claim 1, comprising:
a. a step of obtaining a pseudoboehmite alumina hydrate aqueous solution through a preparation step and a maturing and washing step;
b. a step of obtaining a silica hydrogel aqueous solution;
c. a step of obtaining a silica-alumina mixture aqueous solution by preparing a slurry as a result of mixing the silica hydrogel aqueous solution into an aqueous solution containing the pseudoboehmite alumina hydrate aqueous solution and a basic substance, and then by subjecting said slurry to reaction promotion at a temperature of 40 to 95° C. for 10 minutes to 6 hours; and
d. a step of obtaining silica-alumina particles by drying the silica-alumina mixture aqueous solution,
wherein in the maturing and washing step in the step a, maturing is performed by adding an aluminate aqueous solution at a ratio of 10 to 25% by mass in terms of alumina relative to a total amount of alumina.

4. A manufacturing method of the porous silica-alumina particles according to claim 2, comprising:
a. a step of obtaining a pseudoboehmite alumina hydrate aqueous solution through a preparation step and a maturing and washing step;
b. a step of obtaining a silica hydrogel aqueous solution;
c. a step of obtaining a silica-alumina mixture aqueous solution by preparing a slurry as a result of mixing the silica hydrogel aqueous solution into an aqueous solution containing the pseudoboehmite alumina hydrate aqueous solution and a basic substance, and then by subjecting said slurry to reaction promotion at a temperature of 40 to 95° C. for 10 minutes to 6 hours; and
d. a step of obtaining silica-alumina particles by drying the silica-alumina mixture aqueous solution,
wherein in the maturing and washing step in the step a, maturing is performed by adding an aluminate aqueous solution at a ratio of 10 to 25% by mass in terms of alumina relative to a total amount of alumina.
